(19) United States
(12) Patent Application Publication
(10) Pub. No.: US 2026/0100806 A1
(43) Pub. Date: Apr. 9, 2026

(54) RESOURCE MUTING CONFIGURATION

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Jae Ho RYU, San Diego, CA (US)

(21) Appl. No.: 18/911,210

(22) Filed: Oct. 9, 2024

(51) Int. Cl. H04L 5/14; H04W 72/0453; H04W 72/21

(52) U.S. Cl. CPC H04L 5/14; H04W 72/0453; H04W 72/21

(57) ABSTRACT

A wireless node may one or more memories, individually or in combination, having instructions. A wireless node may one or more processors, individually or in combination, configured to execute the instructions and cause the apparatus to: obtain a configuration associated with resource muting; and output, via a first subset of subband full duplex (SBFD) resources, first signaling for transmission, wherein a second subset of SBFD resources are muted according to the configuration associated with resource muting.

### BACKGROUND

### Technical Field

The present disclosure generally relates to communication systems, and more particularly, to resource muting configurations.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects relate to an apparatus for wireless communication. The apparatus may include one or more memories, individually or in combination, having instructions, and one or more processors, individually or in combination, configured to execute the instructions. In some examples, the one or more processors may cause the apparatus to obtain a configuration associated with resource muting. In some examples, the one or more processors may cause the apparatus to output, via a first subset of subband full duplex (SBFD) resources, first signaling for transmission, wherein a second subset of SBFD resources are muted according to the configuration associated with resource muting.

Certain aspects relate to an apparatus for wireless communication. The apparatus may include one or more memories, individually or in combination, having instructions, and one or more processors, individually or in combination, configured to execute the instructions. In some examples, the one or more processors may cause the apparatus to output for transmission a configuration associated with resource muting. In some examples, the one or more processors may cause the apparatus to obtain, via a first subset of subband full duplex (SBFD) resources, first signaling, wherein a second subset of SBFD resources are muted according to the configuration associated with resource muting.

Certain aspects relate to a method for wireless communication at a wireless node. In some examples, the method includes obtaining a configuration associated with resource muting. In some examples, the method includes outputting, via a first subset of subband full duplex (SBFD) resources, first signaling for transmission, wherein a second subset of SBFD resources are muted according to the configuration associated with resource muting.

Certain aspects relate to a method for wireless communication at a wireless node. In some examples, the method includes outputting for transmission a configuration associated with resource muting. In some examples, the method includes obtaining, via a first subset of subband full duplex (SBFD) resources, first signaling, wherein a second subset of SBFD resources are muted according to the configuration associated with resource muting.

Certain aspects relate to an apparatus. In some examples, the apparatus includes means for obtaining a configuration associated with resource muting. In some examples, the apparatus includes means for outputting, via a first subset of subband full duplex (SBFD) resources, first signaling for transmission, wherein a second subset of SBFD resources are muted according to the configuration associated with resource muting.

Certain aspects relate to an apparatus. In some examples, the apparatus includes means for outputting for transmission a configuration associated with resource muting. In some examples, the apparatus includes means for obtaining, via a first subset of subband full duplex (SBFD) resources, first signaling, wherein a second subset of SBFD resources are muted according to the configuration associated with resource muting.

Certain aspects relate to a non-transitory computer-readable medium comprising instructions that, when executed by a wireless node, cause the wireless node to perform a method. In some examples, the method includes obtaining a configuration associated with resource muting. In some examples, the method includes outputting, via a first subset of subband full duplex (SBFD) resources, first signaling for transmission, wherein a second subset of SBFD resources are muted according to the configuration associated with resource muting.

Certain aspects relate to a non-transitory computer-readable medium comprising instructions that, when executed by a wireless node, cause the wireless node to perform a method. In some examples, the method includes outputting for transmission a configuration associated with resource muting. In some examples, the method includes obtaining, via a first subset of subband full duplex (SBFD) resources, first signaling, wherein a second subset of SBFD resources are muted according to the configuration associated with resource muting.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram conceptually illustrating time-frequency resources for in-band full duplex (IBFD) wireless communication schemes.

FIG. 6 is a block diagram conceptually illustrating time-frequency resources for a subband full duplex (SBFD) scheme that includes a first downlink subband, an uplink subband, and a second downlink subband.

FIGS. 7A-7C illustrate various modes of duplex communication.

FIG. 8 is a block diagram illustrating example uplink resources available in a slot.

FIG. 9 is a block diagram illustrating example time-frequency resources for an SBFD scheme that includes a first downlink subband, a second downlink subband, and an uplink subband.

FIG. 10 is a flowchart of a method of wireless communication.

FIG. 11 is a diagram illustrating an example of a hardware implementation for an example apparatus.

FIG. 12 is a flowchart of a method of wireless communication.

FIG. 13 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In certain aspects, wireless communications use orthogonal frequency division multiplexing (OFDM) in both downlink (DL) (e.g., from a network entity, gNB, or base station, to a user equipment (UE)) and uplink (UL) (e.g., from UE to gNB). In the time domain, downlink and uplink are organized into subframes (e.g., 1 millisecond (ms) each in length), and further divided into multiple slots of equal duration. The slot length depends on subcarrier spacing. For subcarrier spacing of Δf=15 kHz, there may be one slot per subframe, and each slot may include 14 OFDM symbols.

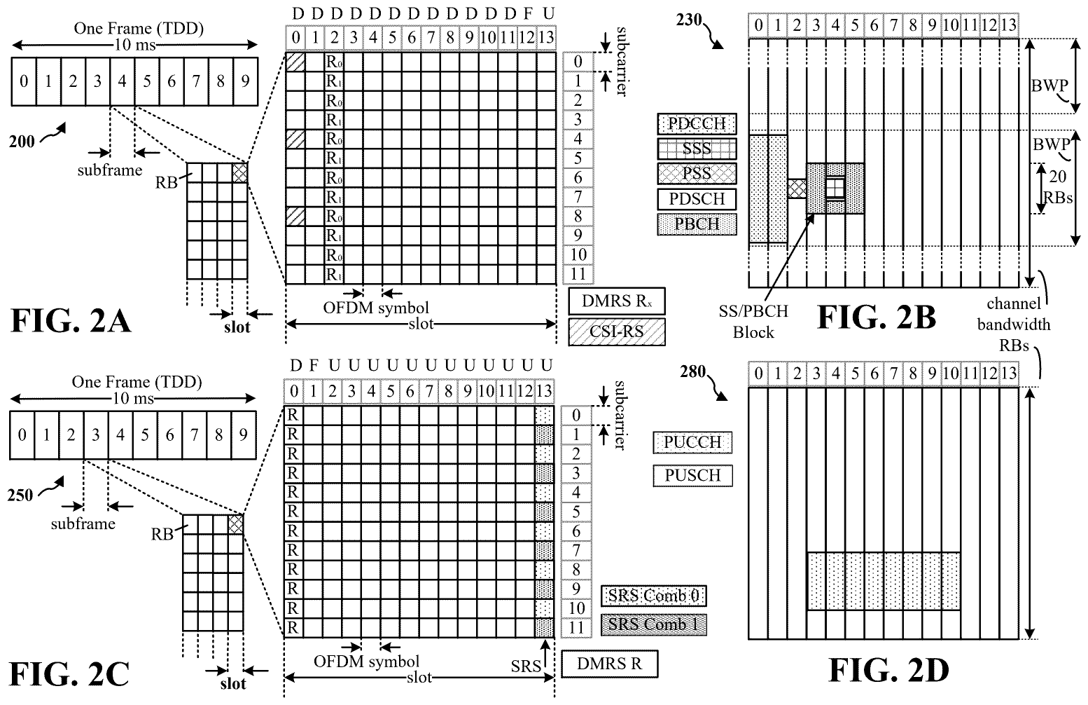

Data scheduling is typically performed on a slot basis. For example, a 14-symbol slot is illustrated in FIG. 2B, where the first two symbols contain a physical downlink control channel (PDCCH) and the rest contain a physical shared data channel (e.g., physical downlink shared channel (PDSCH) and/or physical uplink shared channel (PUSCH)). Uplink data transmission (e.g., PUSCH) can be dynamically scheduled using PDCCH. A UE may decode an uplink grant in PDCCH and then transmit data via PUSCH based the decoded control information (e.g., modulation order, coding rate, uplink resource allocation, etc.) in the uplink grant.

In addition to dynamic scheduling, semi-persistent transmission of PUSCH using configured grants (CGs) is also supported. There are generally two types of CG based PUSCH. In CG type 1, a periodicity of PUSCH transmission as well as the time domain offset are configured by radio resource control (RRC) messaging. In CG type 2, a periodicity of PUSCH transmission is configured by RRC and then an activation and release of such transmission is controlled by downlink control information (DCI) (e.g., via PDCCH).

Full duplex communication is a system where data transmission and reception occur simultaneously. Traditionally, full duplex systems require two separate frequency bands to enable simultaneous transmission and reception of wireless signals. In contrast, subband full duplex (SBFD) allows simultaneous transmission and reception within the same frequency band. For example, the frequency band may be split into multiple subbands to support both uplink and downlink transmissions.

While SBFD can potentially double spectral efficiency relative to traditional full duplex systems, SBFD may contribute to cross-link interference (CLI). For example, SBFD communications may contribute to CLI between two different network entities due to overlapping frequency bands used for simultaneous transmission and reception. Because the same frequency band is split into multiple subbands to support SBFD, the transmission of one network entity on a subband may interfere with another network entity's reception on the same subband, thereby causing CLI between the two network entities.

Accordingly, network entities may perform CLI measurements at times in order to determine whether CLI is causing a negative impact on wireless communications and/or to determine the extent to which CLI is present. However, in some examples, a CLI measurement performed by a network entity may not provide an accurate estimation of CLI caused by a neighboring network entity if the CLI measurement is performed on signaling that includes signaling from other devices, such as UEs.

Thus, aspects of the disclosure are directed to methods and techniques for reducing/eliminating interference from uplink signaling so that a network entity may accurately measure CLI caused by a neighboring network entity.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

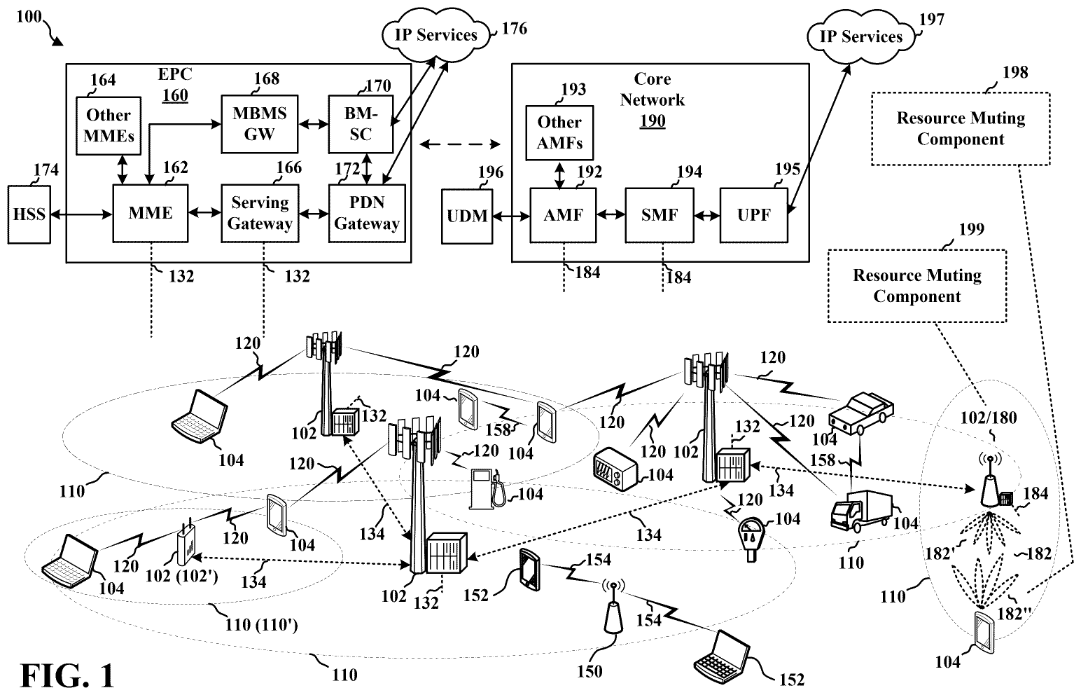

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a resource muting component 198. As described in more detail elsewhere herein, the resource muting component 198 may be configured to obtain a configuration associated with resource muting; and output, via a first subset of subband full duplex (SBFD) resources, first signaling for transmission, wherein a second subset of SBFD resources are muted according to the configuration associated with resource muting. Additionally, or alternatively, the resource muting component 198 may perform one or more other operations described herein.

The base station 102/180 may include a resource muting component 199. As described in more detail elsewhere herein, the resource muting component 199 may be configured to output for transmission a configuration associated with resource muting; and obtain, via a first subset of subband full duplex (SBFD) resources, first signaling, wherein a second subset of SBFD resources are muted according to the configuration associated with resource muting. Additionally, or alternatively, the resource muting component 199 may perform one or more other operations described herein.

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28,respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0 , each slot may include 14 symbols, and for slot configuration 1 , each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1 , different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

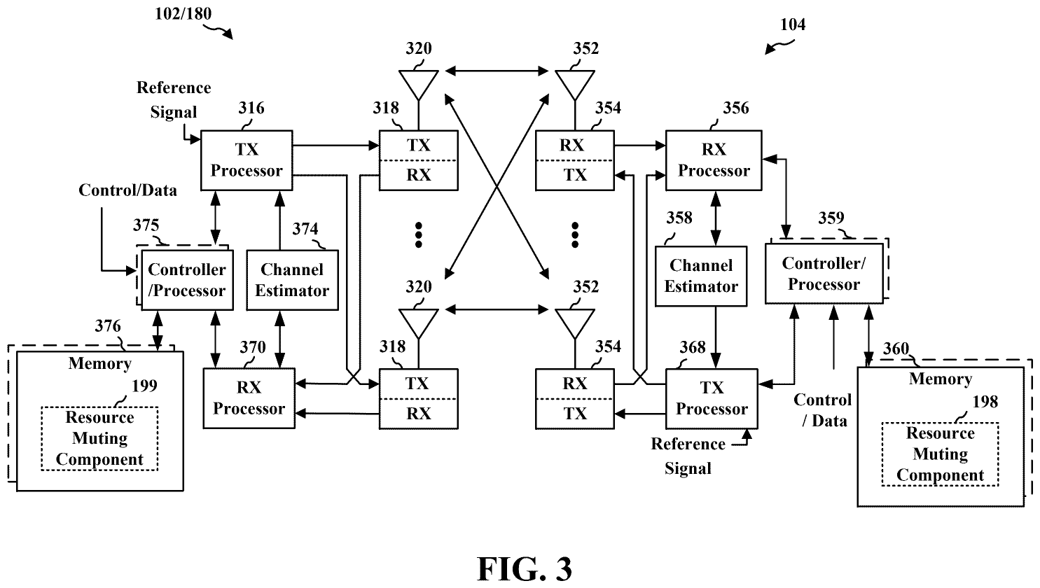

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

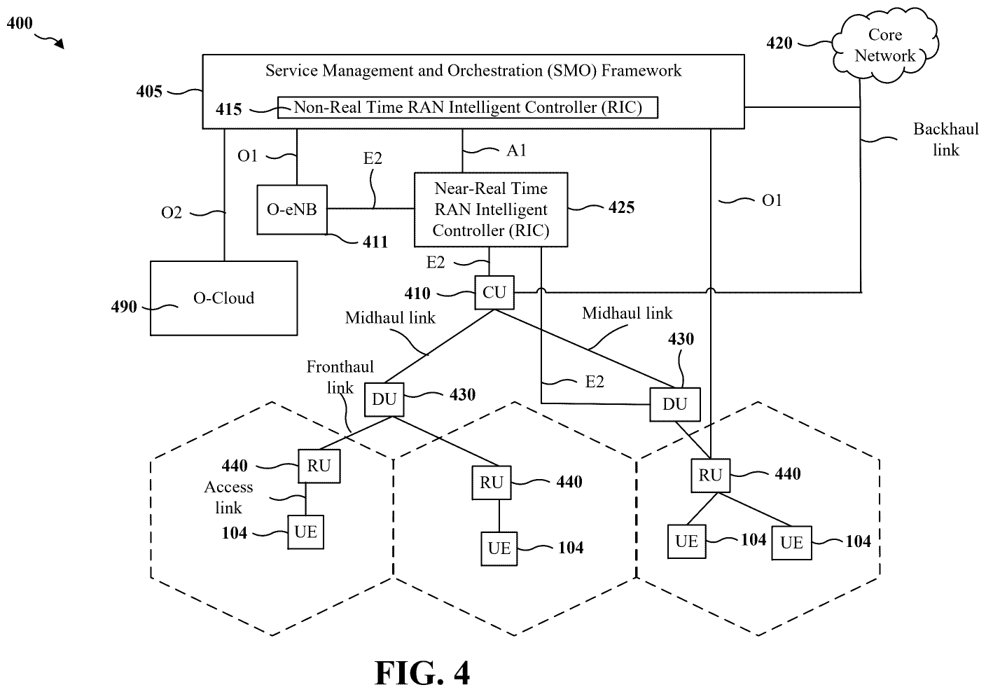

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Full Duplex Communications

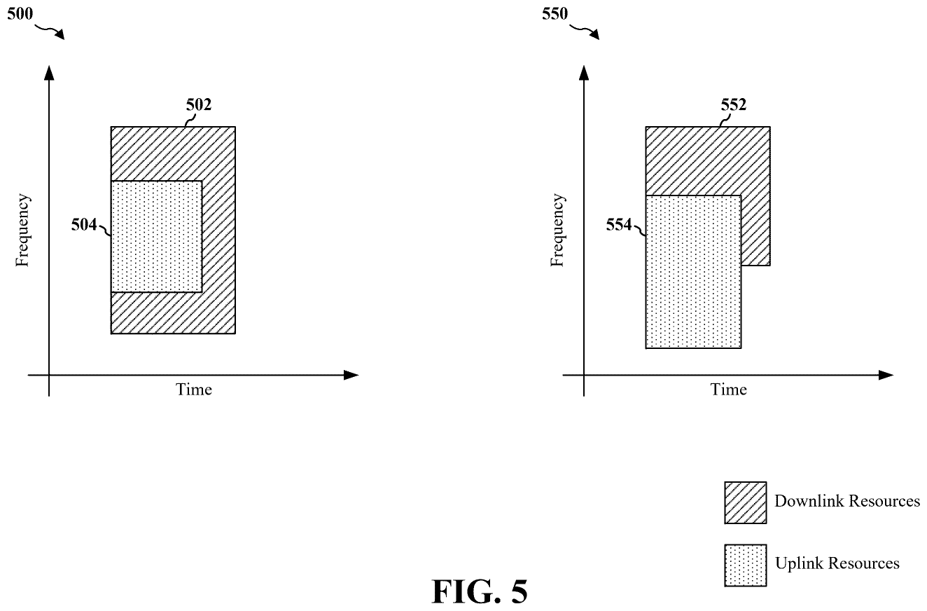

FIG. 5 is a block diagram conceptually illustrating time-frequency resources for in-band full duplex (IBFD) wireless communication schemes. A first IBFD scheme 500 shows a full overlap of downlink resources 502 and uplink resources 504 in time and frequency. That is, a downlink transmission and an uplink transmission share the same time and frequency resources. The downlink resources 502 and uplink resources 504 may be resources used for a UE-to-UE communication link or a UE-to-gNB communication link. A second IBFD scheme 550 shows a partial overlap of downlink resources 552 with uplink resources 554. Here, the downlink resources 552 and the uplink resources 554 are offset from each other by frequency and/or time.

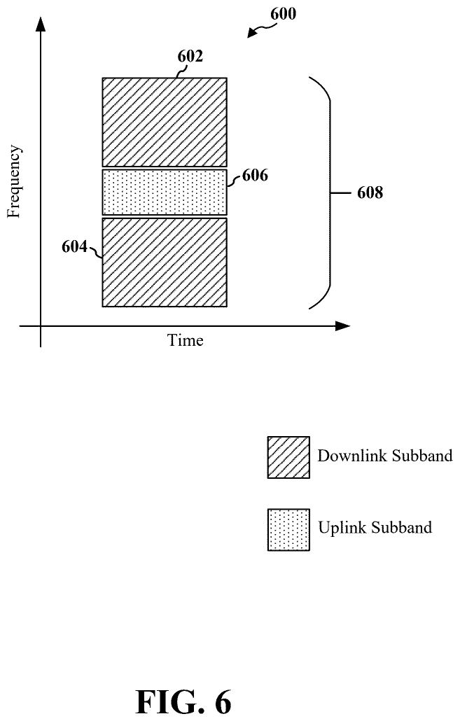

FIG. 6 is a block diagram conceptually illustrating time-frequency resources for an SBFD scheme 600 that includes a first downlink subband 602, an uplink subband 606, and a second downlink subband 604. In some examples, a bandwidth 608 of the aggregated subbands may correspond to a system bandwidth or a component carrier bandwidth. Thus, from the perspective of a UE, a first antenna array may be dedicated to downlink reception via the downlink subband 602, whereas a second antenna array may be dedicated to uplink transmission via the uplink subband 604. Note that neither the uplink subband 606 nor the downlink subbands 602/604 occupy the entire frequency resource range (e.g., the frequency band) for SBFD communication.

Thus, in one example, an SBFD slot may relate to a slot in which the corresponding frequency band is separated into subbands, with each subband dedicated for one of uplink or downlink transmissions. The uplink and downlink transmissions may occur in adjacent bands (e.g., subbands) as opposed to an IBFD communication with overlapping bands. In a given SBFD slot, a half-duplex UE may either transmit in the uplink band or receive in the downlink band, while a full duplex UE may transmit in the uplink band and/or receive in the downlink band of the same slot.

### Examples of Cross Link Interference (CLI)

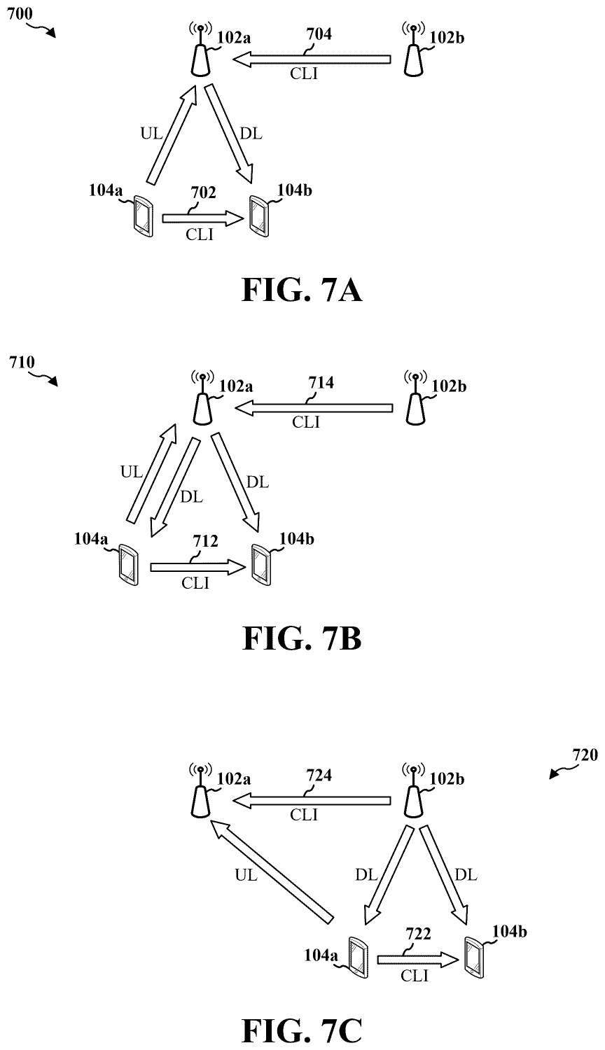

FIGS. 7A, 7B, and 7C illustrate various modes of duplex communication. As discussed, full-duplex communication may support transmission and reception of information (e.g., uplink and downlink communication) in the same frequency range (e.g., on one or more frequency bands) in a manner that overlaps in time. The frequency range may include a common set of frequency bands (e.g., the same frequency bands), fully overlapping frequency bands, or partially overlapping frequency bands. For example, in-band full-duplex (IBFD) operation may include the transmission and reception of signals at overlapping times and overlapping in frequency. In subband full duplex (SBFD), transmission and reception resources may overlap in time using different frequencies, e.g., separated by a guard band. The transmission and reception frequency resources may be close enough that interference cancellation methods are used to cancel interference from the transmitted signal. In this manner, the full-duplex communication may have an improved spectral efficiency relative to a half-duplex (HD) communication, which may support transmission or reception of information in one direction at a time without overlapping uplink and downlink communication. A UE or a network entity operating in the full-duplex mode may simultaneously transmit and receive full-duplex communication. However, in full duplex, the UE or network entity may experience cross-link interference (CLI) from other network devices, such as transmissions from another UE or another network entity. Such interference may impact the quality of the communication, or even lead to a loss of information.

FIG. 7A illustrates a first example of full-duplex communication 700 in which a first network entity 102a (e.g., network entity 102 of FIGS. 1 and 3) may be in full-duplex communication with a first UE 104a (e.g., UE 104 of FIGS. 1 and 3) and a second UE 104b. The first network entity 102a may be a full-duplex network entity. Although the first UE 104a and the second UE 104b are illustrated as communicating in a half-duplex mode, either UE may be configured for half-duplex or full-duplex communication. The first UE 104a may be in proximity to the second UE 104b and may transmit a first uplink signal to the first network entity 102a. The first network entity 102a may transmit a downlink signal to the second UE 104b concurrently with receiving the uplink signal from the first UE 104a. The second UE 104b may experience a first instance of CLI 702 caused by the uplink signals transmitted from the first UE 104a (e.g., the second UE 104b receives interference from the uplink signals while receiving the downlink signaling from the first network entity 102a). The first network entity 102a may experience a second instance of CLI 704 due to signals from the second network entity 102b (e.g., the first network entity 102a receives interference from signals transmitted by the second network entity 102b while receiving the uplink signaling from the first UE 104a).

FIG. 7B shows a second example of full-duplex communication 710 in which a first network entity 102a may be in full-duplex communication with a first UE 104a. In this example, the first network entity 102a may be a full-duplex network entity, and the first UE 104a may also be a full-duplex UE. That is, the first network entity 102a and the first UE 104a may concurrently receive and transmit communication that overlaps in time in the same frequency band. A second UE 104b may experience a first instance of CLI 712 based on one or more uplink signals transmitted from the first UE 104a. Moreover, the first network entity 102a may experience a second instance of CLI 714 caused by a collision of signals transmitted from a second network entity 102b and uplink signals transmitted by the first UE 104a.

FIG. 7C shows a third example of full-duplex communication 720 in which a first UE 104a is a full-duplex UE in communication with a first network entity 102a and a second network entity 102b. The first network entity 102a and the second network entity 102b may serve as multiple transmission and reception points (multi-TRPs) for UL and DL communication with the first UE 104a. The second network entity 102b may also be in communication with a second UE 104b. In FIG. 7C, the first UE 104a may concurrently transmit an uplink signal to the first network entity 102a while receiving a downlink signal from the second network entity 102b. The second UE 104b may experience a first instance of CLI 722 a result of the uplink signaling from the first UE 104a being transmitted at the same time the second UE 104b receives a downlink signal. The first network entity 102a may also experience a second instance of CLI 724 caused by signals transmitted by the second network entity 102b and uplink signaling transmitted by the first UE 104a.

### Examples of Rate Matching Patterns for Muting Resources in Subband Full Duplex (SBFD) Communications

As discussed above, CLI may cause data loss and latencies associated with full duplex communications. Accordingly, full duplex wireless communications systems could be improved with interference management mechanisms for measuring and reporting CLI. Referring to aspects of the examples of FIGS. 7A-7C, a network entity (e.g., first network entity 102a of FIGS. 7A-7C) may determine to perform a channel estimation process to measure CLI between it and another network entity (e.g., the second network entity 102b of FIGS. 7A-7C). However, if both of a first UE (e.g., first UE 104a of FIGS. 7A-7C) and the second network entity 102a are transmitting signaling to the first network entity 102a at the same time, uplink signaling from the first UE 104a may reduce the accuracy of an estimation of the channel between the first network entity 102a and the second network entity 102b.

In certain aspects, the first UE 104a may be configured to mute (e.g., via rate-matching) one or more resources allocated to the first UE 104a for an uplink transmission. That is, the first UE 104a may refrain from transmitting via one or more resources within a set of uplink resources. This allows the first network entity 104a an opportunity to measure those one or more resources for CLI (e.g., the second instance of CLI 704/714/724 of FIGS. 7A-7C) without uplink signaling transmitted via the same one or more resources by the first UE 104a. In this way, CLI measurements may be performed with a much greater accuracy.

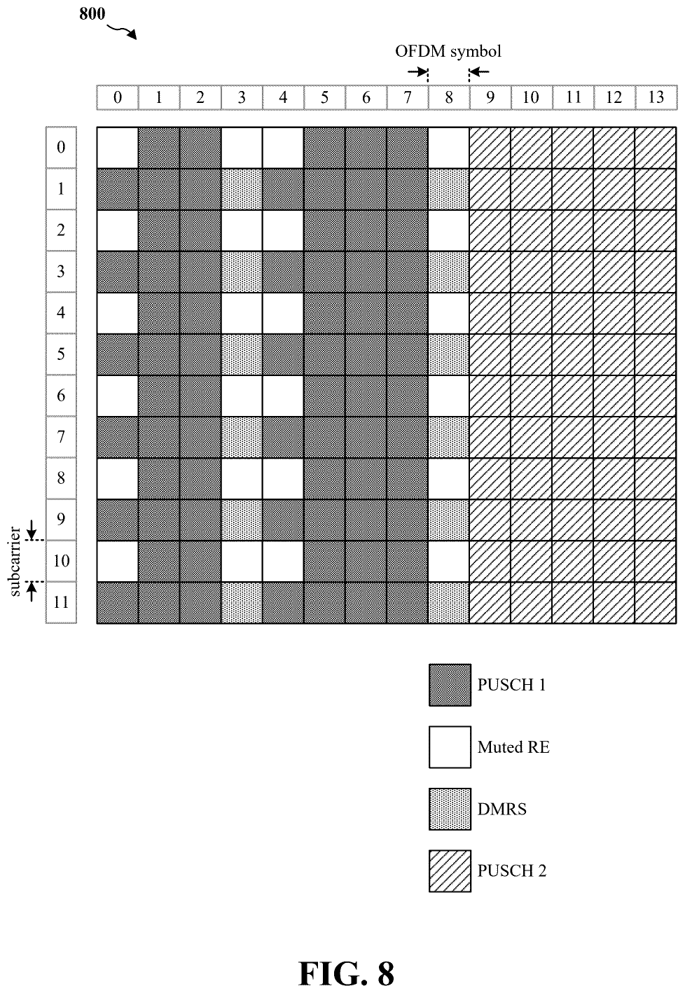

FIG. 8 is a block diagram illustrating example SBFD uplink resources available in a slot 800. Here, the slot 800 is defined by 14 symbols and 12 subcarriers. In some examples, a UE may be configured to transmit uplink signaling via a slot having one or more symbols muted. However, this results in all 12 subcarriers associated with each of the one or more symbols being muted. Consequently, the uplink signaling via such slots may be less efficient than uplink signaling via a slot where entire symbols are not muted.

Thus, in some examples, one or more REs associated with one or more symbols may be muted. As illustrated in the example of FIG. 8, every other RE of certain symbols may be muted (e.g., according to a comb-2 rate-matching pattern). Specifically, every other RE in symbols 0, 3, 4, and 8 may be muted (e.g., the UE refrains from transmitting uplink signaling via the muted resources). In some examples, the muted REs may be defined by a rate-match pattern. Accordingly, of the SBFD uplink resources illustrated, the UE may transmit uplink signaling via a first subset of the SBFD uplink resources (e.g., PUSCH 1, DMRS, PUSCH 2, etc.), while muting a second subset of the SBFD uplink resources (e.g., muted REs). Note that the first subset of SBFD resources does not overlap with the second subset, and that both the first subset and the second subset form a whole of the SBFD uplink resources illustrated.

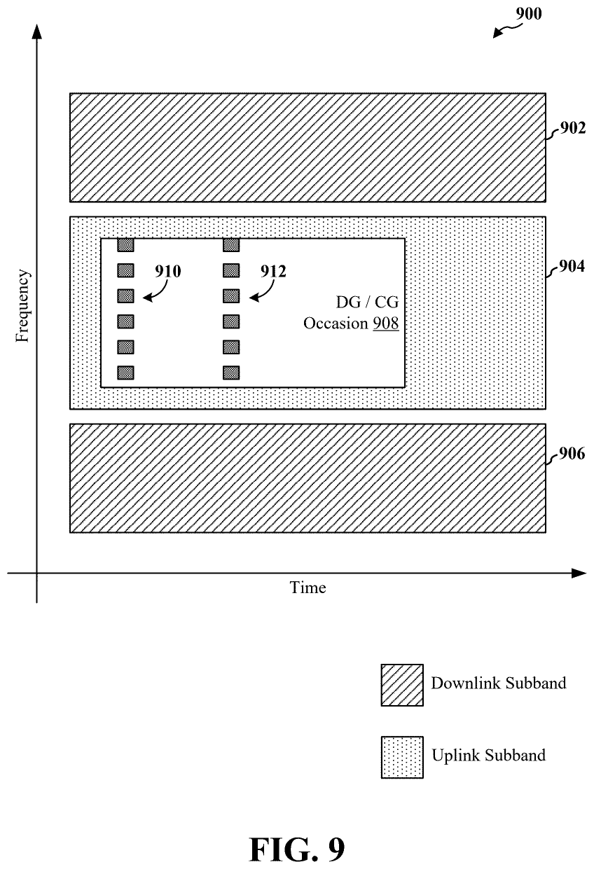

FIG. 9 is a block diagram illustrating example time-frequency resources for an SBFD scheme 900 that includes a first downlink subband 902, a second downlink subband 906, and an uplink subband 904. The uplink subband 904 includes a set of resources (e.g., uplink occasion) that a UE may use to transmit uplink communications, wherein the uplink occasion was provided to the UE via a dynamic grant (DG) or configured grant (CG) (e.g., DG/CG occasion 908). Here, the UE is configured to mute a first set of REs 910 of a first symbol, and a second set of REs 912 of a second symbol of the DG/CG occasion 908.

Using the example illustrated in FIG. 7A, the first UE 104a may mute the configured first set of REs 910 when it transmits uplink signaling to the first network entity 102a. The first network entity 102a may then measure, via the muted REs, the second instance of CLI 704 caused by the second network entity 102b without interference from the uplink signaling.

In some examples, the configuration of uplink resource muting for a PUSCH transmission may be semi-statically configured. In a first option, a position of each of one or more muting symbols may be pre-configured such that a single uplink muting pattern is applied to one or more uplink transmissions. In other words, the UE may apply the same pattern across multiple uplink transmissions. It should be noted that, although the network entity may not dynamically select different uplink muting patterns, and the UE may not dynamically apply different uplink muting patterns based on determinations made by the network entity, the network entity and/or UE may dynamically activate and/or deactivate the single uplink muting pattern such that the pattern is applied selectively to individual uplink occasions. In a second option, the network entity may pre-configure the UE with multiple uplink muting patterns. Here, the network entity may determine the position of the muting symbol(s) and/or muting REs, and transmit (e.g., via DCI) an indication (e.g., an index value corresponding to the determined pre-configured pattern) of one of the uplink muting patterns that match the determine position. The UE can then apply the uplink muting pattern.

To determine the time location of the muted symbols, the network entity and UE may use a common reference point in time (e.g., a specific point in time within a slot where uplink muting symbols are located). In one example, the starting symbol of a slot that contains uplink muting symbols may be used as the common reference point for PUSCH mapping type A and type B. It should be noted that PUSCH mapping type A and type B refer to different methods of mapping the PUSCH symbols to the available resources. Mapping type A involves mapping the PUSCH symbols to the available resource blocks, while mapping type B involves mapping the PUSCH symbols to the available subcarriers within a resource block.

CG PUSCH relates to a technique used in wireless communication systems to allocate resources for uplink transmissions. In some examples, a CG may specify resources that can be used for uplink transmission and time period of the allocation, which can be used for multiple uplink transmissions during that time period. For example, CG can be used to allocate resources for both periodic and non-periodic uplink transmissions. For periodic transmissions, the CG can be configured to allocate resources at regular intervals, such as every 10 milliseconds. For non-periodic transmissions, the CG can be configured to allocate resources on an as-needed basis, such as when the UE has data to transmit. In some examples, a CG may be configured to further allocate a specific set of time-domain and frequency-domain resources to the UE, as well as the modulation and coding scheme (MCS), the transmit power, and any other suitable transmission parameters.

There are two types of CG PUSCH: Type 1 and Type 2. Type 1 CG PUSCH involves a fixed allocation of resources for a particular UE. That UE is allocated a fixed set of resources for a certain duration, and the grant is configured by the network entity based on, for example, channel conditions and network needs. The UE uses the same set of resources for all PUSCH transmissions during the allocated time period. This type of CG PUSCH is typically used in scenarios where the UE has a stable channel condition, and the resource allocation can be predicted in advance.

Type 2 CG PUSCH, on the other hand, provides a relatively more flexible approach wherein the UE may dynamically adjust the allocated resources based on channel conditions. For example, the network entity may provide the UE with a set of possible resource blocks that can be used for uplink transmission, and the UE may choose the best resource block based on the channel conditions. The UE may also change the transmission parameters, such as the MCS and the transmit power, depending on channel conditions. This type of CG PUSCH is typically used in scenarios where the channel condition is highly variable and unpredictable.

Similar to CG PUSCH, DG PUSCH is also used in wireless communication to allocate resources for uplink transmissions. However, DG PUSCH is used to dynamically allocate resources to a UE. More specifically, DG PUSCH is a type of grant-based transmission where the UE may not be allocated a specific set of resources in advance. Rather, the network entity may dynamically allocate resources to the UE based on, for example, channel conditions and available resources. The grant may specify the resources that can be used for transmission, the modulation and coding scheme (MCS), the transmit power, and other transmission parameters.

### Example Resource Muting Configurations

In certain aspects, a network entity may refrain from configuring a UE to mute uplink resources associated with CG PUSCH communications. For example, a wireless standard (e.g., 3GPP) may prevent uplink resource muting from being applied to one or more of type 1 or type 2 PUSCH.

Alternatively, the network entity may configure the UE to mute uplink resources associated with CG PUSCH communications so that the network entity (or another network entity) may measure CLI based on signaling received over certain resources without interference from uplink transmissions by the UE. In one example, the network entity may transmit a type 1 or type 2 CG PUSCH configuration to the UE via RRC messaging. Here, the RRC messaging may include a non-legacy field configured to indicate one or more of a time-location configuration for the uplink resource muting and/or a frequency configuration for the uplink resource muting. In this example, the term “non-legacy” may relate to Release 19 and later releases of 3GPP standards.

The time-location configuration may be configured to indicate one or more symbol positions within the CG PUSCH resources to which resource muting is applied. For example, the time-location configuration may indicate a symbol index that corresponds to a particular symbol of the CG PUSCH resources. Using the example of FIG. 8, the non-legacy field may indicate that the UE may apply uplink resource muting to symbols 0, 3, 4, and 8 of CG PUSCH resources. Although the foregoing example relates to four symbols associated with uplink muting, any suitable number of symbols may be used for uplink muting, including one symbol or two symbols. In some examples, the non-legacy field may be configured to indicate up to two symbols per slot for uplink resource muting.

The frequency configuration for uplink resource muting may be configured to indicate one or more frequency positions (e.g., a particular resource block and/or a particular subcarrier, etc.) within the CG PUSCH resources to which resource muting is applied. In one example, the frequency configuration may indicate one or more of: (i) a comb offset, (ii) a starting frequency location (e.g., a resource block index), and/or (iii) a quantity of resource blocks for uplink resource muting. Using the example of FIG. 8, the comb offset of the non-legacy field may indicate that the muting pattern begins at subcarrier 0 (e.g., as opposed to subcarrier 1 ). Additionally, or alternatively, the starting frequency location of the non-legacy field may indicate the particular resource block within which the slot 800 resides, and/or a number of resource blocks containing slots for which uplink resource muting is applied.

In one example, the UE may expect that the uplink muting pattern (e.g., a rate-matching pattern) applies to the entire frequency allocation of the CG PUSCH frequency-domain resource allocation (FDRA). Thus, in this example, the frequency configuration may indicate the comb offset, but may omit indication of a starting frequency location and/or a quantity of resource blocks for uplink resource muting. In this example, the 3GPP standard may define a rule that the uplink muting pattern is applied to the entire frequency band associated with the type 1 or type 2 CG PUSCH configuration (e.g., the uplink muting pattern applies to the entire FDRA and is not limited to particular resource blocks within the FDRA). For example, as illustrated in FIG. 9, while the frequency configuration for uplink resource muting may include a comb offset indicative of a starting subcarrier within the DG/CG occasion 908 for the uplink muting pattern, the UE may assume that the uplink muting pattern applies to the entire FDRA allocated by the CG PUSCH configuration.

In certain aspects, the network entity may configure the UE with a zero power (ZP) sounding reference signal (SRS) resource set. As used herein, a ZP SRS corresponds to an SRS pattern (e.g., configured via SRS configuration messaging) that the UE may use to mute resources according to the SRS pattern. That is, instead of transmitting an SRS via resources indicated by the SRS pattern, the UE may refrain from transmitting SRS or any other signaling via those resources.

The ZP SRS resource set may include up to two SRS resources, with each SRS resource of the resource set corresponding to a symbol of a slot. Each ZP SRS resource set may be defined by a comb-2 pattern, wherein every other RE within a particular one or more PUSCH symbols may be muted. In some examples, the RRC messaging used to configure type 1 or type 2 CG PUSCH may include a non-legacy field configured to indicate a particular ZP SRS resource set. In other words, the CG PUSCH configuration may be configured to identify a particular ZP SRS resource set to be used for applying resource muting to the PUSCH. Thus, if the non-legacy field identifies a particular ZP SRS resource or resource set, then the UE may mute resources of the CG PUSCH corresponding to the identified ZP SRS resource or resource set.

In some examples, the UE may use the indicated ZP SRS resources to apply muting to corresponding CG PUSCH resources on a periodic, semi-persistent, or aperiodic basis. For example, the RRC messaging used to configure CG PUSCH may indicate that the UE may apply resource muting to CG PUSCH according to the ZP SRS resources at fixed intervals (e.g., every millisecond, every 10 milliseconds, or every second).

It should be noted that SRS configuration messaging may be configured to indicate an SRS pattern as well as one or more of: a frequency-domain and/or time-domain location of the SRS signals, a duration of the SRS signal transmission, a periodicity of the SRS signal transmission, etc. Thus, in some scenarios, the SRS pattern to be used by a UE for ZP SRS (e.g., resource muting of CG PUSCH resources) may fall outside of the CG PUSCH resources. In other words, the SRS pattern may be configured for resources that do not overlap or only partially overlap with CG PUSCH resources. In such an example, the UE may refrain from applying resource muting to CG PUSCH resources according to an SRS pattern unless the SRS pattern is configured such that it overlaps with a CG PUSCH occasion. That is, the UE may mute resources of CG PUSCH occasions according to an SRS pattern if the SRS configuration for that pattern overlaps with the PUSCH occasion.

In another example, the UE may be configured to ignore certain SRS configuration parameters (e.g., periodicity of the SRS signal transmission, etc.) and apply the corresponding SRS pattern as a ZP SRS to a CG PUSCH occasion. In this example, the UE may mute resources of a CG PUSCH occasion according to an SRS pattern, associated comb offset, and associated symbol(s) even if other SRS configuration parameters of that pattern would cause that patter to not overlap with the CG PUSCH occasion.

In certain aspects, a UE may be configured with a PUSCH occasion via a DG PUSCH configuration. The DG PUSCH configuration may be transmitted by a network entity to a UE via RRC messaging. In some examples, the RRC messaging may include a non-legacy field configured to indicate that the UE may apply muting to one or more resources within a DG PUSCH occasion. The DG PUSCH configuration may include the same information discussed above in connection with the CG PUSCH configuration. Thus, in some examples, the DG PUSCH configuration may indicate the time location and/or frequency location of muted PUSCH symbols, a comb offset, a starting RB index, and/or a number of RBs for PUSCH muting. In other examples, the DG PUSCH configuration may indicate an SRS pattern for PUSCH resource muting, as discussed above. In some examples, the non-legacy field configured to indicate one or more muting resources within a DG PUSCH occasion may be included in the RRC messaging on a per-BWP basis.

In some examples, a type 1 or type 2 CG PUSCH configuration may include a non-legacy field configured to indicate wither the UE may apply resource muting configured by a DG PUSCH configuration to a CG PUSCH occasion. Thus, if the network entity has previously configured the UE with a resource muting configuration for DG PUSCH occasions, the network entity may indicate to the UE via the non-legacy field that the UE may apply the same resource muting configuration to type 1 or type 2 CG PUSCH occasions.

In certain aspects, the RRC signaling that includes the type 1 or type 2 CG PUSCH configuration may include a non-legacy field configured to indicate whether the UE may apply uplink muting signaled via DG PUSCH configuration to CG PUSCH occasions. For example, the non-legacy field may be a 1-bit field.

In certain aspects, the network entity may (pre-)configure the UE with one or more masks, or bit patterns, configured to indicate a subset of PUSCH occasions or resources within a PUSCH occasion. In such an example, the RRC signaling that includes the type 1 or type 2 CG PUSCH configuration may include a non-legacy field configured to identify a particular one of the one or more masks. Here, the UE may apply a resource muting pattern to a subset of PUSCH occasions or resources within a PUSCH occasion as indicated by the mask. In some examples, a network entity may be aware of CLI that is caused by another network entity. For example, the network entity may receive information from the other network entity about the presence of interference caused by CLI. The network entity may use this information to adjust the uplink muting at one or more UEs to avoid or mitigate the effects of CLI.

It should be noted that, in certain aspects, type 2 CG PUSCH may be configured using a combination of RRC signaling and DCI. For example, the RRC signaling may indicate a periodicity of the CG PUSCH, while the DCI signaling may provide other communication parameters (e.g., time-domain resource allocation (TDRA) and/or FDRA).

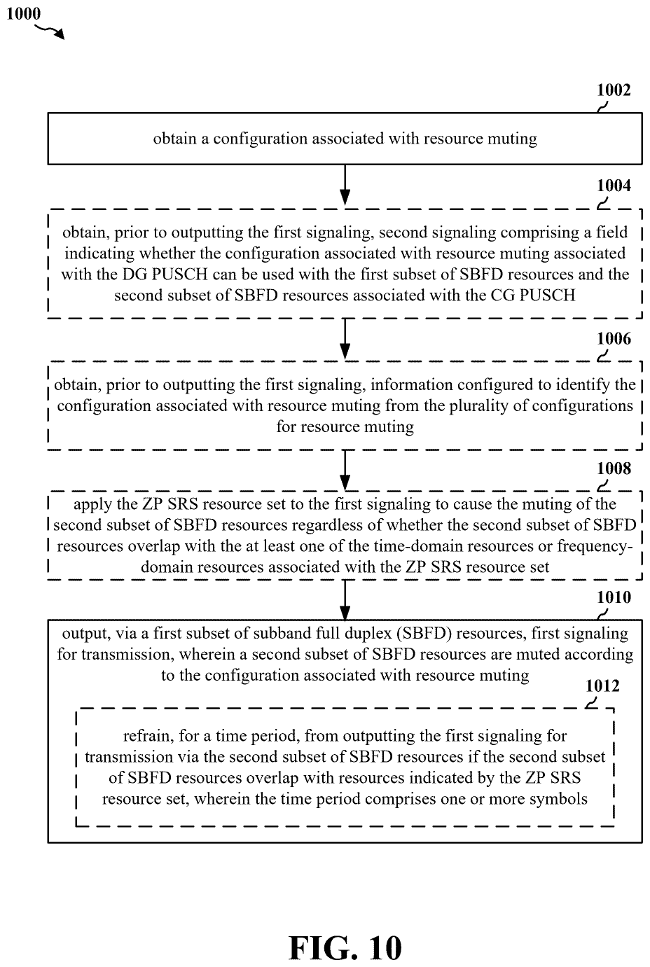

FIG. 10 is a flowchart 1000 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3).

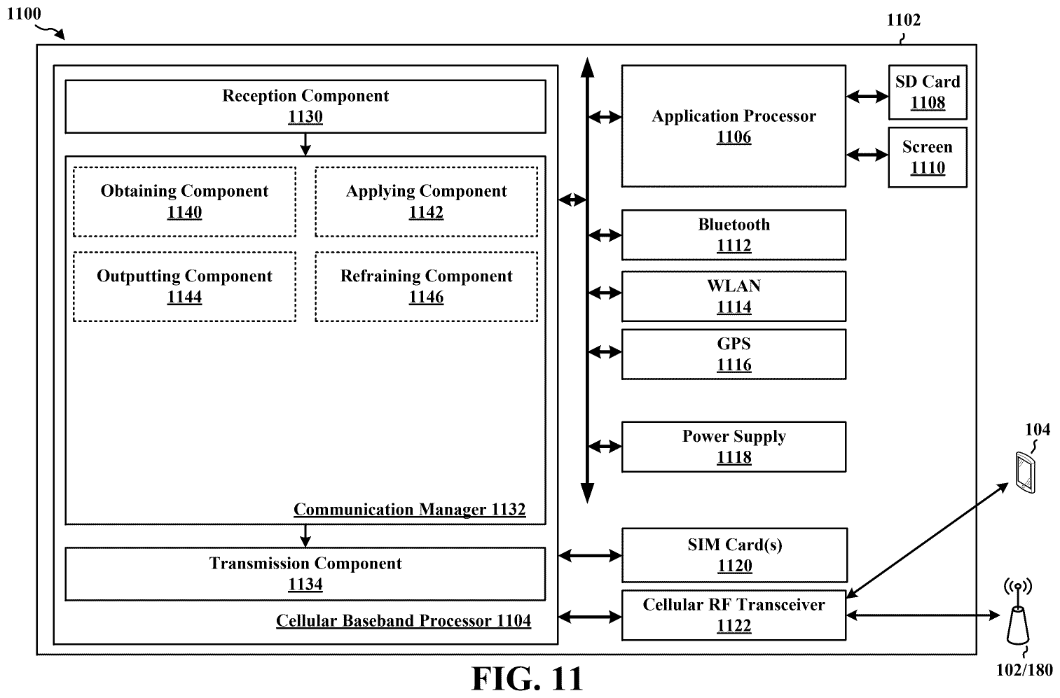

At 1002, the UE may obtain a configuration associated with resource muting. Here, the UE may receive a type 1 or type 2 CG PUSCH RRC configuration message that indicates uplink (e.g., PUSCH) time and/or frequency resources indicative of resources that the UE may “mute.” That is, the UE may refrain from transmitting uplink signaling via the indicates uplink time and/or frequency resources. In some examples, the indication of the indication of the time and/or frequency resources is a non-legacy field of the RRC configuration message. For example, 1002 may be performed by an obtaining component 1140 of FIG. 11.

At 1004, the configuration associated with resource muting is associated with a dynamic grant (DG) PUSCH configuration, and wherein the first subset of SBFD resources and the second subset of SBFD resources are associated with a configured grant (CG) PUSCH. In this example, the UE may optionally obtain, prior to outputting the first signaling, second signaling comprising a field indicating whether the configuration associated with resource muting associated with the DG PUSCH can be used with the first subset of SBFD resources and the second subset of SBFD resources associated with the CG PUSCH. Here, the resource muting configuration may be a configuration for a DG PUSCH. In this case, the network entity may also transmit an indication that the UE is to apply the DG PUSCH resource muting configuration to uplink transmissions configured by CG PUSCH. In some examples, such an indication may be a non-legacy field. For example, 1004 may be performed by the obtaining component 1140 of FIG. 11.

At 1006 , the UE may optionally obtain, prior to outputting the first signaling, information configured to identify the configuration associated with resource muting from the plurality of configurations for resource muting. Here, the network entity may initially configure the UE with a plurality of configurations for resource muting, such as different sets of time and/or frequency locations of resources that the UE may mute during uplink transmission. In this example, the network entity may also transmit signaling configured to indicate a particular one of the plurality of resource muting configurations so that the UE knows which resources to mute during an uplink transmission. In some examples, the indication of the particular one of the plurality of resource muting configurations may be an index or row number associated with a TRDA and/or FDRA table, wherein one or more rows of the TDRA and/or FDRA table includes a reference to a set of time and/or frequency locations of muting resources. In some examples, the indication of the particular one of the plurality of resource muting configurations may be a non-legacy field. Moreover, the reference to the set of time and/or frequency locations of muting resources may be a non-legacy column in the TRDA and/or FDRA table. For example, 1006 may be performed by the obtaining component 1140 of FIG. 11.

At 1008, the configuration associated with resource muting comprises an indication of a zero power (ZP) sounding reference signal (SRS) resource set indicative of at least one muting symbol associated with a ZP SRS resource in the ZP SRS resource set. Moreover, the configuration associated with resource muting may include an indication of at least one of time-domain resources or frequency-domain resources associated with the ZP SRS resource set. In such an example, the UE may optionally apply the ZP SRS resource set to the first signaling to cause the muting of the second subset of SBFD resources regardless of whether the second subset of SBFD resources overlap with the at least one of the time-domain resources or frequency-domain resources associated with the ZP SRS resource set. In other words, the UE may ignore time domain parameters and other parameters associated with the SRS resource set configuration, and instead apply SRS resource set parameters of symbols and comb offset to CG/DG PUSCH occasions. Accordingly, the UE may apply a resource muting pattern to a CG/DG PUSCH occasion that mirrors the SRS pattern. The UE may ignore other SRS communication parameters because those parameters may configure the SRS pattern to be applied to time/frequencies outside of the CG/DG PUSCH occasion. Thus, in order to use the SRS pattern to apply muting to the CG/DG PUSCH occasion, the other SRS communication parameters may need to be ignored. For example, 1008 may be performed by an applying component 1142 of FIG. 11.

At 1010, the UE may output, via a first subset of subband full duplex (SBFD) resources, first signaling for transmission, wherein a second subset of SBFD resources are muted according to the configuration associated with resource muting. Here, the UE may transmit a CG/DG PUSCH communication wherein certain resources within the PUSCH communication are muted to allow the receiving network entity to measure signaling received via those resources for CLI. For example, 1010 may be performed by an outputting component 1144 of FIG. 11.

At 1012, the UE may optionally refrain, for a time period, from outputting the first signaling for transmission via the second subset of SBFD resources if the second subset of SBFD resources overlap with resources indicated by the ZP SRS resource set, wherein the time period comprises one or more symbols. Here, the UE may transmit a CG/DG PUSCH communication wherein certain resources within the PUSCH communication are muted to allow the receiving network entity to measure signaling received via those resources for CLI. In some examples, the UE may only mute PUSCH resources if the PUSCH resources overlap with SRS resources. Thus, this example is the opposite of that described in 1008, because instead of ignoring the SRS communication parameters in order to apply the SRS pattern for PUSCH resource muting, the UE will only perform PUSCH resource muting if the SRS communication parameters relate to resources that overlap with the DG/CG PUSCH resources. For example, 1010 may be performed by an outputting component 1144 of FIG. 11.

In certain aspects, the first signaling is output for transmission based on the first signaling not being associated with a type 1 configured grant (CG) physical uplink shared channel (PUSCH) or a type 2 CG PUSCH.

In certain aspects, the configuration associated with resource muting is obtained via at least one of a radio resource control (RRC) configuration message or a downlink control information (DCI).

In certain aspects, the configuration associated with resource muting further comprises at least one of: (i) a time location configuration of the resource muting, or (ii) a frequency configuration of the resource muting.

In certain aspects, the frequency configuration comprises an indication of at least one of: (i) a comb offset associated with the resource muting, or (ii) a resource block (RB) index and a quantity of RBs associated with the resource muting.

In certain aspects, the time configuration comprises an indication of at least one index corresponding to a symbol associated with resource muting.

In certain aspects, frequency configuration is configured to indicate that the resource muting is to be applied to an entire uplink band of the SBFD resources.

In certain aspects, the configuration associated with resource muting is obtained via a radio resource control (RRC) message, and wherein the RRC further comprises an indication of the ZP SRS resource set.

In certain aspects, the configuration associated with resource muting further comprises a field indicating whether the configuration associated with resource muting associated with the DG PUSCH can be used with the first subset of SBFD resources and the second subset of SBFD resources associated with the CG PUSCH.

In certain aspects, the configuration associated with resource muting is one of a plurality of configurations for resource muting.

In certain aspects, the information is obtained via a radio resource control (RRC) message or a downlink control information (DCI) message.

In certain aspects, the information configured to identity the configuration associated with resource muting comprises an index associated with a time-domain resource allocation (TDRA) table or an index associated with a zero power (ZP) sounding reference signal (SRS) resource set.

In certain aspects, the SBFD resources are associated with a configured grant (CG) PUSCH, and wherein the configuration associated with resource muting further comprises an indication of a mask configured to identify a subset of CG PUSCH occasions that apply the resource muting.

In certain aspects, the configuration associated with resource muting is obtained via a radio resource control (RRC) message, and wherein the configuration associated with resource muting further comprises an indication of the first subset of SBFD resources and the second subset of SBFD resources.

FIG. 11 is a diagram 1100 illustrating an example of a hardware implementation for an apparatus 1102. The apparatus 1102 is a UE and includes a cellular baseband processor 1104 (also referred to as a modem) coupled to one or more cellular RF transceivers 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the one or more cellular RF transceivers 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 104 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see UE 104 of FIG. 3) and include the aforediscussed additional modules of the apparatus 1102. In various examples, the apparatus 1102 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1132 includes an obtaining component 1140 that is configured to: obtain a configuration associated with resource muting; obtain, prior to outputting the first signaling, second signaling comprising a field indicating whether the configuration associated with resource muting associated with the DG PUSCH can be used with the first subset of SBFD resources and the second subset of SBFD resources associated with the CG PUSCH; and obtain, prior to outputting the first signaling, information configured to identify the configuration associated with resource muting from the plurality of configurations for resource muting; e.g., as described in connection with 1002, 1004, and 1006.

The communication manager 1132 further includes an applying component 1142 configured to apply the ZP SRS resource set to the first signaling to cause the muting of the second subset of SBFD resources regardless of whether the second subset of SBFD resources overlap with the at least one of the time-domain resources or frequency-domain resources associated with the ZP SRS resource set, e.g., as described in connection with 1008.

The communication manager 1132 further includes an outputting component 1144 configured to output, via a first subset of subband full duplex (SBFD) resources, first signaling for transmission, wherein a second subset of SBFD resources are muted according to the configuration associated with resource muting, e.g., as described in connection with 1010.

The communication manager 1132 further includes a refraining component 1146 configured to refrain, for a time period, from outputting the first signaling for transmission via the second subset of SBFD resources if the second subset of SBFD resources overlap with resources indicated by the ZP SRS resource set, wherein the time period comprises one or more symbols, e.g., as described in connection with 1012.

The apparatus may include additional components that perform each of the blocks of the algorithm in the aforementioned flowchart of FIG. 10. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes: means for obtaining a configuration associated with resource muting; means for obtaining, prior to outputting the first signaling, second signaling comprising a field indicating whether the configuration associated with resource muting associated with the DG PUSCH can be used with the first subset of SBFD resources and the second subset of SBFD resources associated with the CG PUSCH; means for obtaining, prior to outputting the first signaling, information configured to identify the configuration associated with resource muting from the plurality of configurations for resource muting; means for applying the ZP SRS resource set to the first signaling to cause the muting of the second subset of SBFD resources regardless of whether the second subset of SBFD resources overlap with the at least one of the time-domain resources or frequency-domain resources associated with the ZP SRS resource set; means for outputting, via a first subset of subband full duplex (SBFD) resources, first signaling for transmission, wherein a second subset of SBFD resources are muted according to the configuration associated with resource muting; and means for refraining, for a time period, from outputting the first signaling for transmission via the second subset of SBFD resources if the second subset of SBFD resources overlap with resources indicated by the ZP SRS resource set, wherein the time period comprises one or more symbols.

The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

For example, the means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for applying, means for refraining, means for selecting, and means for determining may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

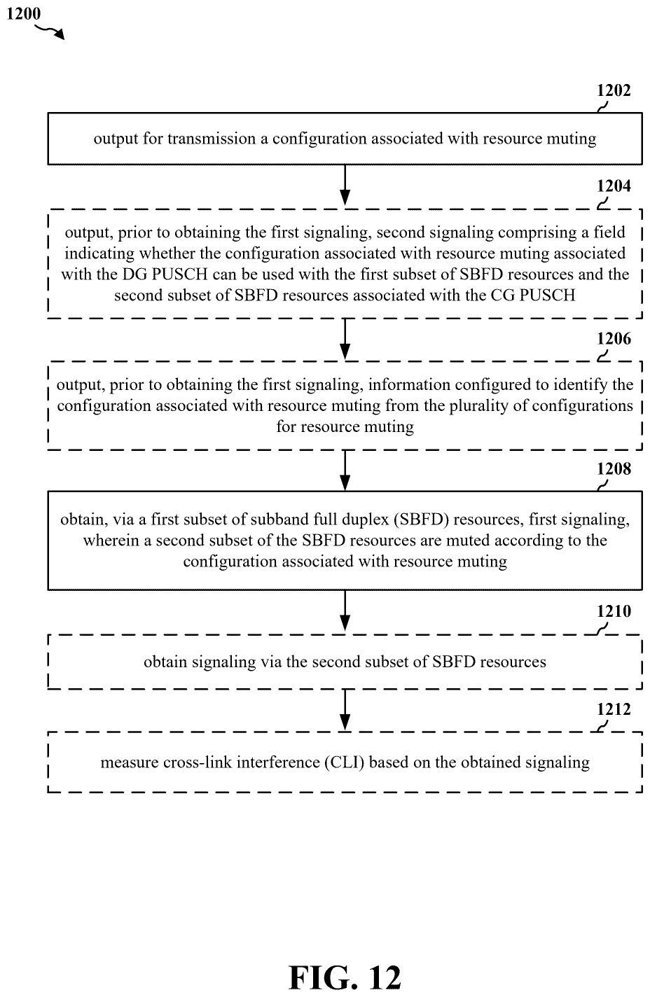

FIG. 12 is a flowchart 1200 of a method of wireless communication. The method may be performed by a network entity or base station (e.g., the base station 102/180; the apparatus 1302. Specifically, the method may be performed by one or more memories, processors, and RF front ends (e.g., the memory 376, controller/processor 375, transmitter 318TX, receiver 318RX, antenna 320, etc. of FIG. 3).

At 1202, the network entity may output for transmission a configuration associated with resource muting. For example, 1202 may be performed by an outputting component 1340.

At 1204, the network entity may optionally output, prior to obtaining the first signaling, second signaling comprising a field indicating whether the configuration associated with resource muting associated with the DG PUSCH can be used with the first subset of SBFD resources and the second subset of SBFD resources associated with the CG PUSCH. For example, 1204 may be performed by an outputting component 1340.

At 1206, the network entity may optionally output, prior to obtaining the first signaling, information configured to identify the configuration associated with resource muting from the plurality of configurations for resource muting. For example, 1206 may be performed by the outputting component 1340.

At 1208, the network entity may obtain, via a first subset of subband full duplex (SBFD) resources, first signaling, wherein a second subset of SBFD resources are muted according to the configuration associated with resource muting. For example, 1208 may be performed by an obtaining component 1342.

At 1210, the network entity may obtain signaling via a second subset of SBFD resources. For example, 1210 may be performed by the obtaining component 1342.

At 1212, the network entity may measure cross-link interference (CLI) based on the obtained signaling. For example, 1212 may be performed by a measuring component 1344.

In certain aspects, the configuration associated with resource muting is outputted for transmission via at least one of a radio resource control (RRC) configuration message or a downlink control information (DCI).

In certain aspects, the configuration associated with resource muting further comprises at least one of: (i) a time location configuration of the resource muting, or (ii) a frequency configuration of the resource muting.

In certain aspects, the frequency configuration comprises an indication of at least one of: (i) a comb offset associated with the resource muting, or (ii) a resource block (RB) index and a quantity of RBs associated with the resource muting.

In certain aspects, the time configuration comprises an indication of at least one index corresponding to a symbol associated with resource muting.

In certain aspects, the frequency configuration is configured to indicate that the resource muting is to be applied to an entire uplink band of the first subset of SBFD resources and the second subset of SBFD resources.

In certain aspects, the configuration associated with resource muting comprises an indication of a zero power (ZP) sounding reference signal (SRS) resource set indicative of at least one muting symbol associated with a ZP SRS resource in the ZP SRS resource set.

In certain aspects, the configuration associated with resource muting is outputted for transmission via a radio resource control (RRC) message, and wherein the RRC further comprises an indication of the ZP SRS resource set.

In certain aspects, the configuration associated with resource muting is associated with a dynamic grant (DG) PUSCH configuration, and wherein the first subset of SBFD resources and the second subset of SBFD resources are associated with a configured grant (CG) PUSCH.

In certain aspects, the configuration associated with resource muting further comprises a field indicating whether the configuration associated with resource muting associated with the DG PUSCH can be used with the first subset of SBFD resources and the second subset of SBFD resources associated with the CG PUSCH.

In certain aspects, the configuration associated with resource muting is one of a plurality of configurations for resource muting.

In certain aspects, the information is output for transmission via a radio resource control (RRC) message or a downlink control information (DCI) message.

In certain aspects, the information configured to identity the configuration associated with resource muting comprises an index associated with a time-domain resource allocation (TDRA) table or an index associated with a zero power (ZP) sounding reference signal (SRS) resource set.

In certain aspects, the SBFD resources are associated with a configured grant (CG) PUSCH, and wherein the configuration associated with resource muting further comprises an indication of a mask configured to identify a subset of CG PUSCH occasions that apply the resource muting.

In certain aspects, the configuration associated with resource muting is obtained via a radio resource control (RRC) message, and wherein the configuration associated with resource muting further comprises an indication of the first subset of SBFD resources and the second subset of SBFD resources.

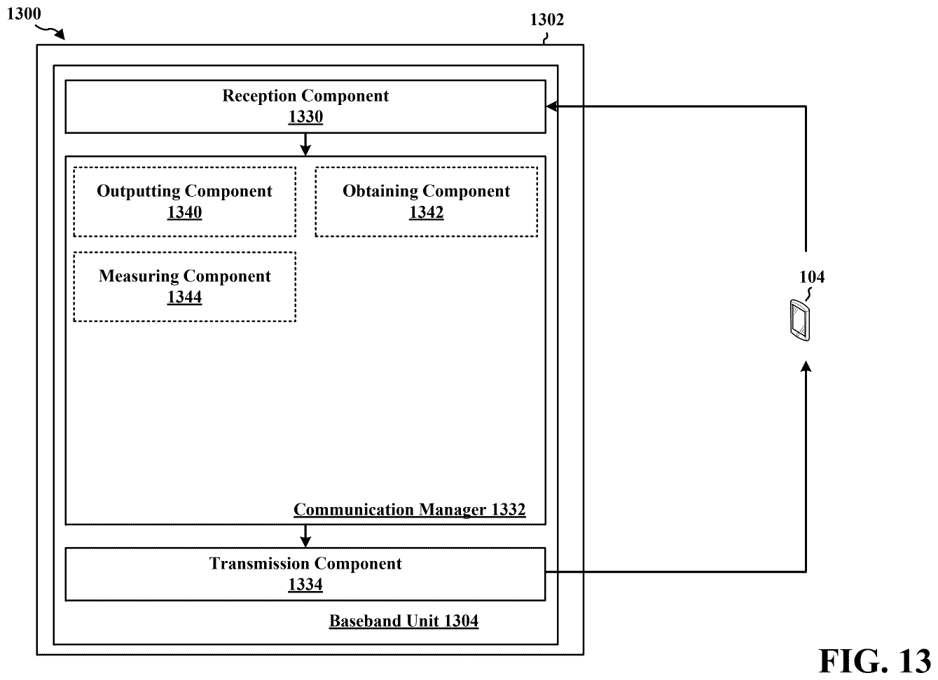

FIG. 13 is a diagram 1300 illustrating an example of a hardware implementation for an apparatus 1302. The apparatus 1302 is a network entity or base station (BS) and includes a baseband unit 1304. The baseband unit 1304 may communicate through one or more cellular RF transceivers with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 102/180 and may include the memory 376 and/or at least one of the TX processor 316, the RX processor 370, and the controller/processor 375. In various examples, the apparatus 1302 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1332 includes an outputting component 1340 configured to: output for transmission a configuration associated with resource muting; output, prior to obtaining the first signaling, second signaling comprising a field indicating whether the configuration associated with resource muting associated with the DG PUSCH can be used with the first subset of SBFD resources and the second subset of SBFD resources associated with the CG PUSCH; and output, prior to obtaining the first signaling, information configured to identify the configuration associated with resource muting from the plurality of configurations for resource muting; e.g., as described in connection with 1202, 1204, and 1206.

The communication manager 1332 further includes an obtaining component 1342 configured to: obtain, via a first subset of subband full duplex (SBFD) resources, first signaling, wherein a second subset of SBFD resources are muted according to the configuration associated with resource muting; and obtain signaling via a second subset of SBFD resources; e.g., as described in connection with 1208 and 1210.

The communication manager 1332 further includes a measuring component 1344 configured to: measure cross-link interference (CLI) based on the obtained signaling, e.g., as described in connection with 1212.

The apparatus may include additional components that perform each of the blocks of the algorithm in the aforementioned flowchart of FIG. 12. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes: means for outputting for transmission a configuration associated with resource muting; means for outputting, prior to obtaining the first signaling, second signaling comprising a field indicating whether the configuration associated with resource muting associated with the DG PUSCH can be used with the first subset of SBFD resources and the second subset of SBFD resources associated with the CG PUSCH; means for outputting, prior to obtaining the first signaling, information configured to identify the configuration associated with resource muting from the plurality of configurations for resource muting; means for obtaining, via a first subset of subband full duplex (SBFD) resources, first signaling, wherein a second subset of SBFD resources are muted according to the configuration associated with resource muting; means for obtaining signaling via the at least some of the SBFD resources; and means for measuring cross-link interference (CLI) based on the obtained signaling.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3. Means for selecting, means for measuring, means for determining, and means for generating may include a processing system, which may include one or more processors, such as the controller/processor 375, the memory 376, and/or any other suitable hardware components of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a wireless node (e.g., UE), comprising: obtaining a configuration associated with resource muting; and outputting, via a first subset of subband full duplex (SBFD) resources, first signaling for transmission, wherein a second subset of SBFD resources are muted according to the configuration associated with resource muting.

Example 2 is the method of Example 1, wherein the first signaling is output for transmission based on the first signaling not being associated with a type 1 configured grant (CG) physical uplink shared channel (PUSCH) or a type 2 CG PUSCH.

Example 3 is the method of any of Examples 1 and 2, wherein the configuration associated with resource muting is obtained via at least one of a radio resource control (RRC) configuration message or a downlink control information (DCI).

Example 4 is the method of any of Examples 1-3, wherein the configuration associated with resource muting further comprises at least one of: (i) a time location configuration of the resource muting, or (ii) a frequency configuration of the resource muting.

Example 5 is the method of Example 4, wherein the frequency configuration comprises an indication of at least one of: (i) a comb offset associated with the resource muting, or (ii) a resource block (RB) index and a quantity of RBs associated with the resource muting.

Example 6 is the method of any of Examples 4 and 5, wherein the time configuration comprises an indication of at least one index corresponding to a symbol associated with resource muting.

Example 7 is the method of any of Examples 4-6, wherein the frequency configuration is configured to indicate that the resource muting is to be applied to an entire uplink band of the first subset of SBFD resources and the second subset of SBFD resources.

Example 8 is the method of any of Examples 1-7, wherein the configuration associated with resource muting comprises an indication of a zero power (ZP) sounding reference signal (SRS) resource set indicative of at least one muting symbol associated with a ZP SRS resource in the ZP SRS resource set.

Example 9 is the method of claim 8, wherein the configuration associated with resource muting is obtained via a radio resource control (RRC) message, and wherein the RRC further comprises an indication of the ZP SRS resource set.

Example 10 is the method of any of Examples 8 and 9, further comprising: refraining, for a time period, from outputting the first signaling for transmission via the second subset of SBFD resources if the second subset of SBFD resources overlap with resources indicated by the ZP SRS resource set, wherein the time period comprises one or more symbols.

Example 11 is the method of any of Examples 8-10, wherein the configuration associated with resource muting further comprises an indication of at least one of time-domain resources or frequency-domain resources associated with the ZP SRS resource set, and wherein the method further comprises: applying the ZP SRS resource set to the first signaling to cause the muting of the second subset of SBFD resources regardless of whether the second subset of SBFD resources overlap with the at least one of the time-domain resources or frequency-domain resources associated with the ZP SRS resource set.

Example 12 is the method of any of Examples 1-11, wherein the configuration associated with resource muting is associated with a dynamic grant (DG) PUSCH configuration, and wherein the first subset of SBFD resources and the second subset of SBFD resources are associated with a configured grant (CG) PUSCH.

Example 13 is the method of Example 12, further comprising: obtaining, prior to outputting the first signaling, second signaling comprising a field indicating whether the configuration associated with resource muting associated with the DG PUSCH can be used with the first subset of SBFD resources and the second subset of SBFD resources associated with the CG PUSCH.

Example 14 is the method of any of Examples 12 and 13, wherein the configuration associated with resource muting further comprises a field indicating whether the configuration associated with resource muting associated with the DG PUSCH can be used with the first subset of SBFD resources and the second subset of SBFD resources associated with the CG PUSCH.

Example 15 is the method of any of Examples 1-14, wherein the configuration associated with resource muting is one of a plurality of configurations for resource muting, and wherein the method further comprises: obtaining, prior to outputting the first signaling, information configured to identify the configuration associated with resource muting from the plurality of configurations for resource muting.

Example 16 is the method of Example 15, wherein the information is obtained via a radio resource control (RRC) message or a downlink control information (DCI) message.

Example 17 is the method of any of Examples 15 and 16, wherein the information configured to identity the configuration associated with resource muting comprises an index associated with a time-domain resource allocation (TDRA) table or an index associated with a zero power (ZP) sounding reference signal (SRS) resource set.

Example 18 is the method of any of Examples 1-17, wherein the SBFD resources are associated with a configured grant (CG) PUSCH, and wherein the configuration associated with resource muting further comprises an indication of a mask configured to identify a subset of CG PUSCH occasions that apply the resource muting.

Example 19 is the method of any of Examples 1-18, wherein the configuration associated with resource muting is obtained via a radio resource control (RRC) message, and wherein the configuration associated with resource muting further comprises an indication of the first subset of SBFD resources and the second subset of SBFD resources.

Example 20 is a method for wireless communication at a wireless node (e.g., network entity), comprising: outputting for transmission a configuration associated with resource muting; and obtaining, via a first subset of subband full duplex (SBFD) resources, first signaling, wherein a second subset of SBFD resources are muted according to the configuration associated with resource muting.

Example 21 is the method of Example 20, wherein the configuration associated with resource muting is outputted for transmission via at least one of a radio resource control (RRC) configuration message or a downlink control information (DCI).

Example 22 is the method of any of Examples 20 and 21, wherein the configuration associated with resource muting further comprises at least one of: (i) a time location configuration of the resource muting, or (ii) a frequency configuration of the resource muting.

Example 23 is the method of Example 22, wherein the frequency configuration comprises an indication of at least one of: (i) a comb offset associated with the resource muting, or (ii) a resource block (RB) index and a quantity of RBs associated with the resource muting.

Example 24 is the method of any of Examples 22 and 23, wherein the time configuration comprises an indication of at least one index corresponding to a symbol associated with resource muting.

Example 25 is the method of any of Examples 22-24, wherein the frequency configuration is configured to indicate that the resource muting is to be applied to an entire uplink band of the first subset of SBFD resources and the second subset of SBFD resources.

Example 26 is the method of any of Examples 20-25, wherein the configuration associated with resource muting comprises an indication of a zero power (ZP) sounding reference signal (SRS) resource set indicative of at least one muting symbol associated with a ZP SRS resource in the ZP SRS resource set.

Example 27 is the method of Example 26, wherein the configuration associated with resource muting is outputted for transmission via a radio resource control (RRC) message, and wherein the RRC further comprises an indication of the ZP SRS resource set.

Example 28 is the method of any of Examples 20-27, wherein the configuration associated with resource muting is associated with a dynamic grant (DG) PUSCH configuration, and wherein the first subset of SBFD resources and the second subset of SBFD resources are associated with a configured grant (CG) PUSCH.

Example 29 is the method of Example 28, further comprising: outputting, prior to obtaining the first signaling, second signaling comprising a field indicating whether the configuration associated with resource muting associated with the DG PUSCH can be used with the first subset of SBFD resources and the second subset of SBFD resources associated with the CG PUSCH.

Example 30 is the method of any of Examples 28 and 29, wherein the configuration associated with resource muting further comprises a field indicating whether the configuration associated with resource muting associated with the DG PUSCH can be used with the first subset of SBFD resources and the second subset of SBFD resources associated with the CG PUSCH.

Example 31 is the method of any of Examples 20-30, wherein the configuration associated with resource muting is one of a plurality of configurations for resource muting, and wherein the method further comprises: outputting, prior to obtaining the first signaling, information configured to identify the configuration associated with resource muting from the plurality of configurations for resource muting.

Example 32 is the method of Example 31, wherein the information is output for transmission via a radio resource control (RRC) message or a downlink control information (DCI) message.

Example 33 is the method of any of Examples 31 and 32, wherein the information configured to identity the configuration associated with resource muting comprises an index associated with a time-domain resource allocation (TDRA) table or an index associated with a zero power (ZP) sounding reference signal (SRS) resource set.

Example 34 is the method of any of Examples 20-33, wherein the SBFD resources are associated with a configured grant (CG) PUSCH, and wherein the configuration associated with resource muting further comprises an indication of a mask configured to identify a subset of CG PUSCH occasions that apply the resource muting.

Example 35 is the method of any of Examples 20-34, wherein the configuration associated with resource muting is obtained via a radio resource control (RRC) message, and wherein the configuration associated with resource muting further comprises an indication of the first subset of SBFD resources and the second subset of SBFD resources.

Example 36 is the method of any of Examples 20-35, wherein method further comprises: obtaining signaling via the at least some of the SBFD resources; and measuring cross-link interference (CLI) based on the obtained signaling.

Example 37 is an apparatus for wireless communications, comprising means for performing a method in accordance with any one of examples 1-19.

Example 38 is an apparatus for wireless communications, comprising means for performing a method in accordance with any one of examples 20-36.

Example 39 is a non-transitory computer-readable medium comprising instructions that, when executed by a wireless node (e.g., UE), cause the wireless node to perform a method in accordance with any one of examples 1-19.

Example 40 is a non-transitory computer-readable medium comprising instructions that, when executed by a wireless node (e.g., network entity), cause the wireless node to perform a method in accordance with any one of examples 20-36.

Example 41 is an apparatus for wireless communications, comprising: one or more memories, individually or in combination, having instructions; and one or more processors, individually or in combination, configured to execute the instructions and cause the apparatus to perform a method in accordance with any one of examples 1-19.

Example 42 is an apparatus for wireless communications, comprising: one or more memories, individually or in combination, having instructions; and one or more processors, individually or in combination, configured to execute the instructions and cause the apparatus to perform a method in accordance with any one of examples 20-36.

Example 43 is a wireless node (e.g., UE), comprising: one or more transceivers; one or more memories, individually or in combination, having instructions; and one or more processors, individually or in combination, configured to execute the instructions and cause the wireless node to perform a method in accordance with any one of examples 1-19, wherein the one or more transceivers are configured to: receive the configuration associated with the resource muting; and transmit the first signaling.

Example 44 is a wireless node (e.g., network entity), comprising: one or more transceivers; one or more memories, individually or in combination, having instructions; and one or more processors, individually or in combination, configured to execute the instructions and cause the wireless node to perform a method in accordance with any one of examples 20-36, wherein the one or more transceivers are configured to: transmit the configuration associated with the resource muting; and receive the first signaling.

What is claimed is:

1. An apparatus for wireless communication, comprising:
one or more memories, individually or in combination, having instructions; and
one or more processors, individually or in combination, configured to execute the instructions and cause the apparatus to:
obtain a configuration associated with resource muting; and
output, via a first subset of subband full duplex (SBFD) resources, first signaling for transmission, wherein a second subset of SBFD resources are muted according to the configuration associated with resource muting.

2. The apparatus of claim 1, wherein the first signaling is output for transmission based on the first signaling not being associated with a type 1 configured grant (CG) physical uplink shared channel (PUSCH) or a type 2 CG PUSCH.

3. The apparatus of claim 1, wherein the configuration associated with resource muting is obtained via at least one of a radio resource control (RRC) configuration message or a downlink control information (DCI).

4. The apparatus of claim 1, wherein the configuration associated with resource muting further comprises at least one of: (i) a time location configuration of the resource muting, or (ii) a frequency configuration of the resource muting.

5. The apparatus of claim 4, wherein the frequency configuration comprises an indication of at least one of: (i) a comb offset associated with the resource muting, or (ii) a resource block (RB) index and a quantity of RBs associated with the resource muting.

6. The apparatus of claim 4, wherein the time configuration comprises an indication of at least one index corresponding to a symbol associated with resource muting.

7. The apparatus of claim 4, wherein the frequency configuration is configured to indicate that the resource muting is to be applied to an entire uplink band of the first subset of SBFD resources and the second subset of SBFD resources.

8. The apparatus of claim 1, wherein the configuration associated with resource muting comprises an indication of a zero power (ZP) sounding reference signal (SRS) resource set indicative of at least one muting symbol associated with a ZP SRS resource in the ZP SRS resource set.

9. The apparatus of claim 8, wherein the configuration associated with resource muting is obtained via a radio resource control (RRC) message, and wherein the RRC further comprises an indication of the ZP SRS resource set.

10. The apparatus of claim 8, wherein the one or more processors, being configured to output, via the first subset of SBFD resources, first signaling for transmission according to the configuration associated with resource muting, are configured to cause the apparatus to:
refrain, for a time period, from outputting the first signaling for transmission via the second subset of SBFD resources if the second subset of SBFD resources overlap with resources indicated by the ZP SRS resource set, wherein the time period comprises one or more symbols.

11. The apparatus of claim 8, wherein the configuration associated with resource muting further comprises an indication of at least one of time-domain resources or frequency-domain resources associated with the ZP SRS resource set, and wherein the one or more processors, being configured to output, via the first subset of SBFD resources, first signaling for transmission according to the configuration associated with resource muting, are configured to cause the apparatus to:
apply the ZP SRS resource set to the first signaling to cause the muting of the second subset of SBFD resources regardless of whether the second subset of SBFD resources overlap with the at least one of the time-domain resources or frequency-domain resources associated with the ZP SRS resource set.

12. The apparatus of claim 1, wherein the configuration associated with resource muting is associated with a dynamic grant (DG) PUSCH configuration, and wherein the first subset of SBFD resources and the second subset of SBFD resources are associated with a configured grant (CG) PUSCH.

13. The apparatus of claim 12, wherein the one or more processors are further configured to cause the apparatus to:
obtain, prior to outputting the first signaling, second signaling comprising a field indicating whether the configuration associated with resource muting associated with the DG PUSCH can be used with the first subset of SBFD resources and the second subset of SBFD resources associated with the CG PUSCH.

14. The apparatus of claim 12, wherein the configuration associated with resource muting further comprises a field indicating whether the configuration associated with resource muting associated with the DG PUSCH can be used with the first subset of SBFD resources and the second subset of SBFD resources associated with the CG PUSCH.

15. The apparatus of claim 1, wherein the configuration associated with resource muting is one of a plurality of configurations for resource muting, and wherein the one or more processors are further configured to cause the apparatus to:
obtain, prior to outputting the first signaling, information configured to identify the configuration associated with resource muting from the plurality of configurations for resource muting.

16. The apparatus of claim 15, wherein the information is obtained via a radio resource control (RRC) message or a downlink control information (DCI) message.

17. The apparatus of claim 15, wherein the information configured to identity the configuration associated with resource muting comprises an index associated with a time-domain resource allocation (TDRA) table or an index associated with a zero power (ZP) sounding reference signal (SRS) resource set.

18. The apparatus of claim 1, wherein the first subset of SBFD resources and the second subset of SBFD resources are associated with a configured grant (CG) PUSCH, and wherein the configuration associated with resource muting further comprises an indication of a mask configured to identify a subset of CG PUSCH occasions that apply the resource muting.

19. The apparatus of claim 1, wherein the configuration associated with resource muting is obtained via a radio resource control (RRC) message, and wherein the configuration associated with resource muting further comprises an indication of the first subset of SBFD resources and the second subset of SBFD resources.

20. The apparatus of claim 1, further comprising one or more transceivers configured to:
receive the configuration associated with resource muting; and
transmit the first signaling, wherein the apparatus is configured as a user equipment (UE).

21. An apparatus for wireless communication, comprising:
one or more memories, individually or in combination, having instructions; and
one or more processors, individually or in combination, configured to execute the instructions and cause the apparatus to:
output for transmission a configuration associated with resource muting; and
obtain, via a first subset of subband full duplex (SBFD) resources, first signaling, wherein a second subset of the SBFD resources are muted according to the configuration associated with resource muting.

22. The apparatus of claim 21, wherein the configuration associated with resource muting is outputted for transmission via at least one of a radio resource control (RRC) configuration message or a downlink control information (DCI).

23. The apparatus of claim 21, wherein the configuration associated with resource muting further comprises at least one of: (i) a time location configuration of the resource muting, or (ii) a frequency configuration of the resource muting.

24. The apparatus of claim 23, wherein the frequency configuration comprises an indication of at least one of: (i) a comb offset associated with the resource muting, or (ii) a resource block (RB) index and a quantity of RBs associated with the resource muting.

25. The apparatus of claim 23, wherein the time configuration comprises an indication of at least one index corresponding to a symbol associated with resource muting.

26. The apparatus of claim 23, wherein the frequency configuration is configured to indicate that the resource muting is to be applied to an entire uplink band of the first subset of SBFD resources and the second subset of SBFD resources.

27. The apparatus of claim 21, wherein the configuration associated with resource muting comprises an indication of a zero power (ZP) sounding reference signal (SRS) resource set indicative of at least one muting symbol associated with a ZP SRS resource in the ZP SRS resource set.

28. The apparatus of claim 27, wherein the configuration associated with resource muting is outputted for transmission via a radio resource control (RRC) message, and wherein the RRC further comprises an indication of the ZP SRS resource set.

29. The apparatus of claim 21, wherein the configuration associated with resource muting is associated with a dynamic grant (DG) PUSCH configuration, and wherein the first subset of SBFD resources and the second subset of SBFD resources are associated with a configured grant (CG) PUSCH.

30. The apparatus of claim 29, wherein the one or more processors are further configured to cause the apparatus to:
output, prior to obtaining the first signaling, second signaling comprising a field indicating whether the configuration associated with resource muting associated with the DG PUSCH can be used with the first subset of SBFD resources and the second subset of SBFD resources associated with the CG PUSCH.

31. The apparatus of claim 29, wherein the configuration associated with resource muting further comprises a field indicating whether the configuration associated with resource muting associated with the DG PUSCH can be used with the first subset of SBFD resources and the second subset of SBFD resources associated with the CG PUSCH.

32. The apparatus of claim 21, wherein the configuration associated with resource muting is one of a plurality of configurations for resource muting, and wherein the one or more processors are further configured to cause the apparatus to:
output, prior to obtaining the first signaling, information configured to identify the configuration associated with resource muting from the plurality of configurations for resource muting.

33. The apparatus of claim 32, wherein the information is output for transmission via a radio resource control (RRC) message or a downlink control information (DCI) message.

34. The apparatus of claim 32, wherein the information configured to identity the configuration associated with resource muting comprises an index associated with a time-domain resource allocation (TDRA) table or an index associated with a zero power (ZP) sounding reference signal (SRS) resource set.

35. The apparatus of claim 21, wherein the SBFD resources are associated with a configured grant (CG) PUSCH, and wherein the configuration associated with resource muting further comprises an indication of a mask configured to identify a subset of CG PUSCH occasions that apply the resource muting.

36. The apparatus of claim 21, wherein the configuration associated with resource muting is obtained via a radio resource control (RRC) message, and wherein the configuration associated with resource muting further comprises an indication of the first subset of SBFD resources and the second subset of SBFD resources.

37. The apparatus of claim 21, wherein the one or more processors are further configured to cause the apparatus to:
obtain signaling via the second subset of SBFD resources; and
measure cross-link interference (CLI) based on the obtained signaling.

38. The apparatus of claim 21, further comprising one or more transceivers configured to:
transmit the configuration associated with resource muting; and
receive the first signaling, wherein the apparatus is configured as a network entity.

39. A method for wireless communication at a wireless node, comprising:
obtaining a configuration associated with resource muting; and
outputting, via a first subset of subband full duplex (SBFD) resources, first signaling for transmission, wherein a second subset of the SBFD resources are muted according to the configuration associated with resource muting.
